(19) United States
(12) Patent Application Publication
(10) Pub. No.: US 2011/0114299 A1
(43) Pub. Date: May 19, 2011

(54) Flat tube with turbulence insert for a heat exchanger, heat exchanger having such flat tubes, as well as method and device for production of such a flat tube

(76) Inventor: Norbert Aplienz, Duelmen (DE)

(21) Appl. No.: 12/653,998

(22) Filed: Dec. 22, 2009

(30) Foreign Application Priority Data
Nov. 17, 2009 (DE) 10 2009 053 579.9

(51) Int. Cl. F28F 1/40; B21D 53/06; B23P 15/26; F28F 1/02; F28F 9/02

(52) U.S. Cl. 165/175; 29/890.045; 29/727; 165/181

(57) ABSTRACT

The present invention relates to a flat tube for heat exchangers, particularly for charge air coolers, having a turbulence insert that lies on the inside, as well as to a heat exchanger, particularly a charge air cooler, having such flat tubes, and to a method for production of such a flat tube.

The present invention relates to a flat tube for heat exchangers, particularly for charge air coolers, having a turbulence insert that lies on the inside, particularly to a charge air cooler having such flat tubes, and to a method as well as a device for production of such a flat tube.

Flat tubes of the type stated usually serve for connecting an inlet collecting container with an outlet collecting container of a heat exchanger, for example a charge air cooler or an oil cooler, by means of flow technology, for which purpose the flat tubes are stacked on top of one another and disposed adjacent to one another with their tube broad sides, and open into the inlet collection container and the outlet collection container with their tube ends, in each instance. Furthermore, metal sheets in the manner of lamellae or corrugations are preferably disposed between the flat tubes, which sheets are soldered to the broad sides of the flat tubes with their vertices. The sheets serve to increase the size of the heat exchanger surface. A liquid or gaseous medium to be cooled, for example charge air, flows through the flat tubes, and a gaseous or liquid medium that takes up heat, preferably air, flows through the metal sheets, whereby a heat exchange between the two media takes place.

In order to improve heat transfer, it is known that the flat tubes have metal turbulence sheets or turbulence inserts. These primarily serve to produce a turbulent flow of the medium flowing through the flat tubes. Furthermore, the turbulence inserts can be soldered to the tube wall of the flat tubes, so that they also serve to increase the internal pressure strength due to a tie rod effect.

The turbulence inserts are, for example, corrugated metal sheets (“wave fins”), which are produced by means of rolling deformation, for example, and form multiple flow chambers adjacent to one another, which extend continuously in a longitudinal tube direction, in each instance. Alternatively to this, the turbulence inserts are so-called offset fins, which form flow chambers, in each instance, which are disposed one behind the other in the longitudinal tube direction, whereby the flow chambers disposed one behind the other are disposed offset relative to one another in a tube transverse direction. In this way, edges disposed offset relative to one another are formed, which edges are impacted by the flow, thereby producing turbulence. A possible embodiment of offset fins is known from DE 10 2006 031 675 A1, for example.

For the production of flat tubes having turbulence inserts that lie on the inside, the pre-fabricated turbulence inserts are usually pushed into the pre-fabricated flat tubes, and it is practical to solder them together. This production method is relatively complicated. In particular, this is a multi-step process in which the flat tubes have to be handled multiple times, and this brings high costs with it.

Furthermore, it is known, for example from DE 10 2006 031 675 A1, to produce the flat tubes, together with the turbulence inserts, in one piece. For this purpose, a section of a flat strip is first continuously deformed to produce an endless turbulence insert, by means of rolling deformation, among other possibilities, whereby the flat strip is left smooth to the side, next to the deformed section. Subsequently, the smooth sections are edged and wound around the deformed section, so that an endless flat tube is formed. The endless flat tube is subsequently welded on the longitudinal side and cut to length.

It is the task of the invention to make available a method and a device by means of which flat tubes for heat exchangers, particularly for charge air coolers, having a turbulence insert that lies on the inside, can be produced in simple, fast, and cost-advantageous manner.

Furthermore, it is the task of the present invention to make available a flat tube for heat exchangers, particularly for charge air coolers, having a turbulence insert that lies on the inside, which can be produced in simple, fast, and cost-advantageous manner, demonstrates great stability against pressure stress from the outside and the inside, and has good heat exchanger properties.

It is a further task of the invention to make available a heat exchanger, particularly a charge air cooler, having such flat tubes.

These tasks are accomplished by means of a method having the characteristics of claim 1, a device having the characteristics of claim 20, a flat tube having the characteristics of claim 22, and a heat exchanger having the characteristics of claim 39.

In the following, the invention will be explained in greater detail using a drawing. This shows:

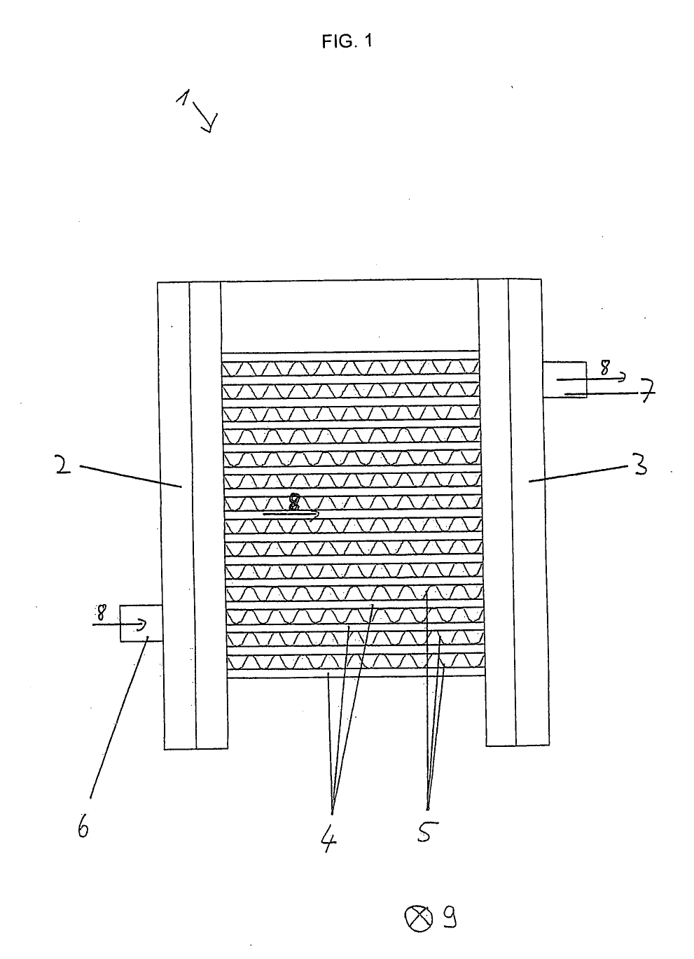

FIG. 1: A schematic view of the heat exchanger according to the invention, from the tube narrow side

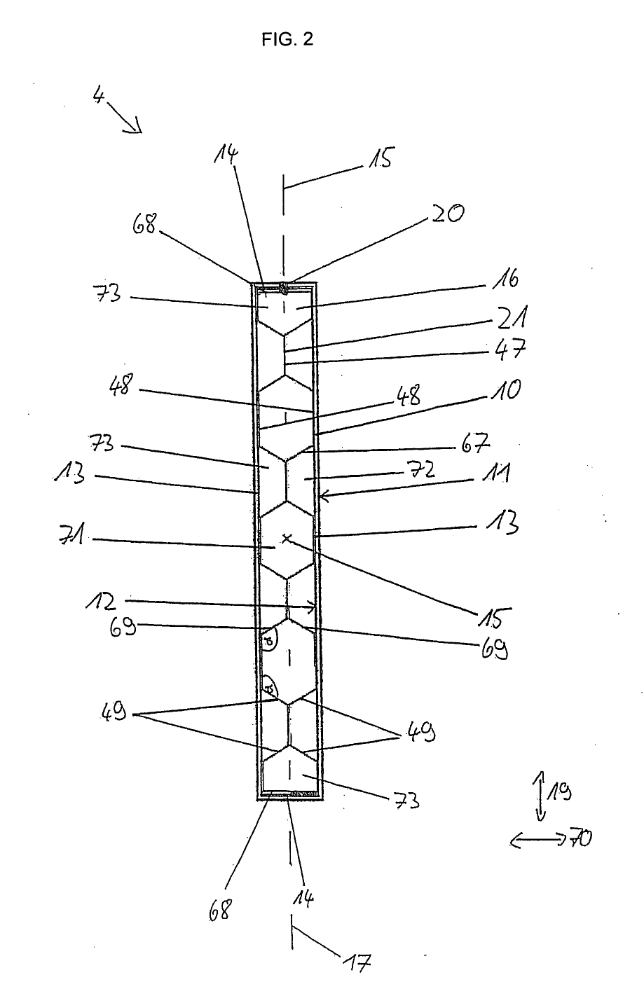

FIG. 2: A schematic cross-section of the flat tube according to the invention

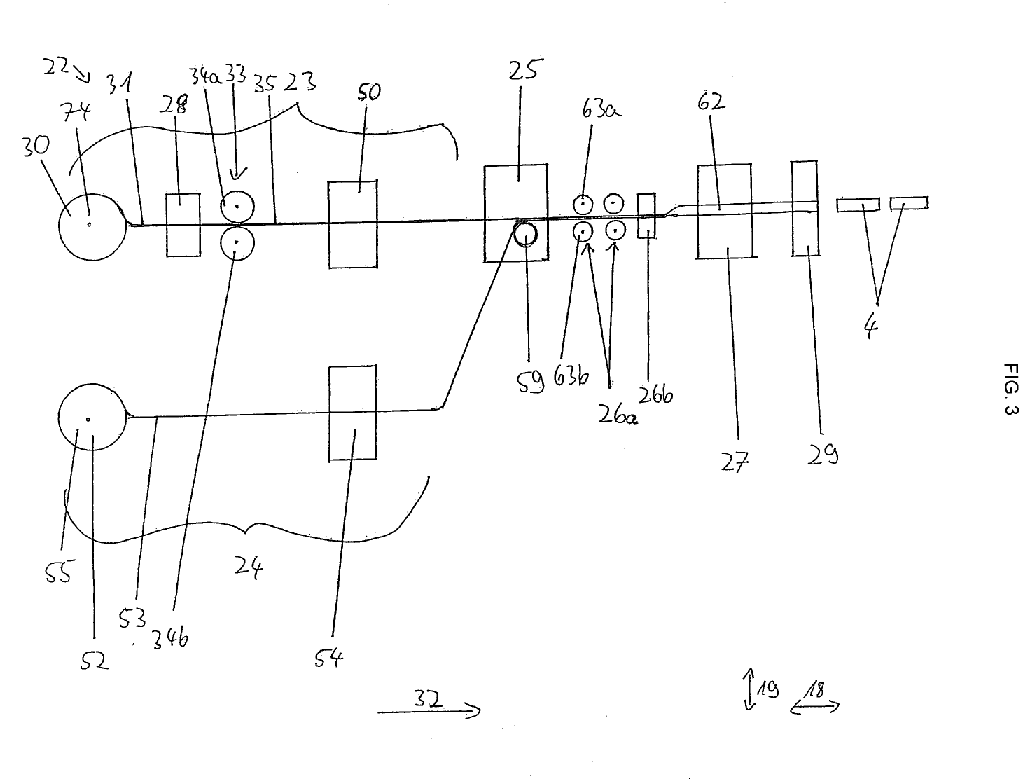

FIG. 3: Schematically, a side view of a device according to the invention

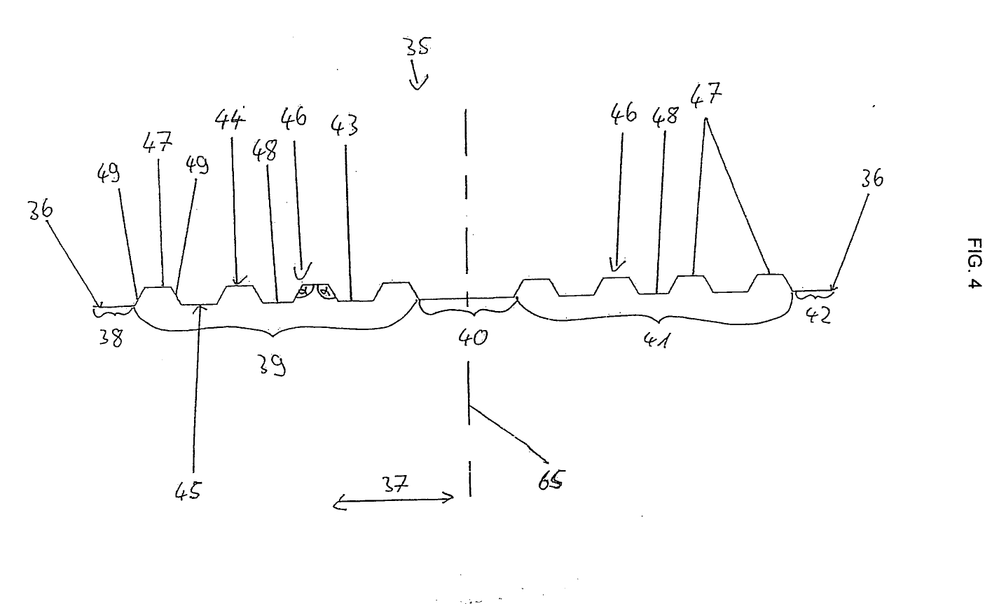

FIG. 4: Schematically, a cross-section of an endless profile sheet that has not been edged

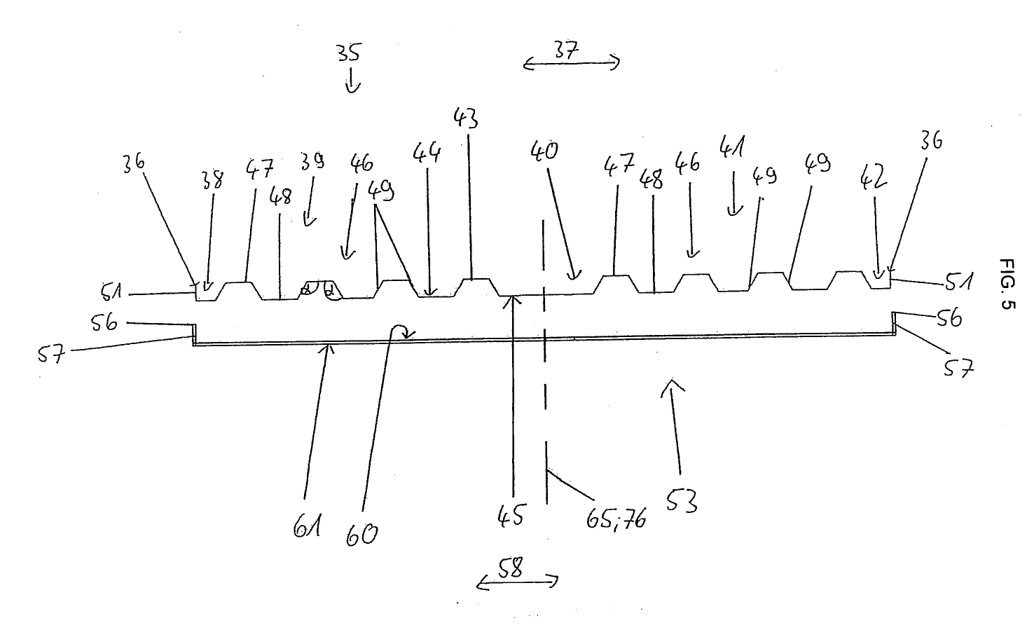

FIG. 5: Schematically, a cross-section of the edged endless profile sheet and an edged endless flat strip material for the production of a tube wall

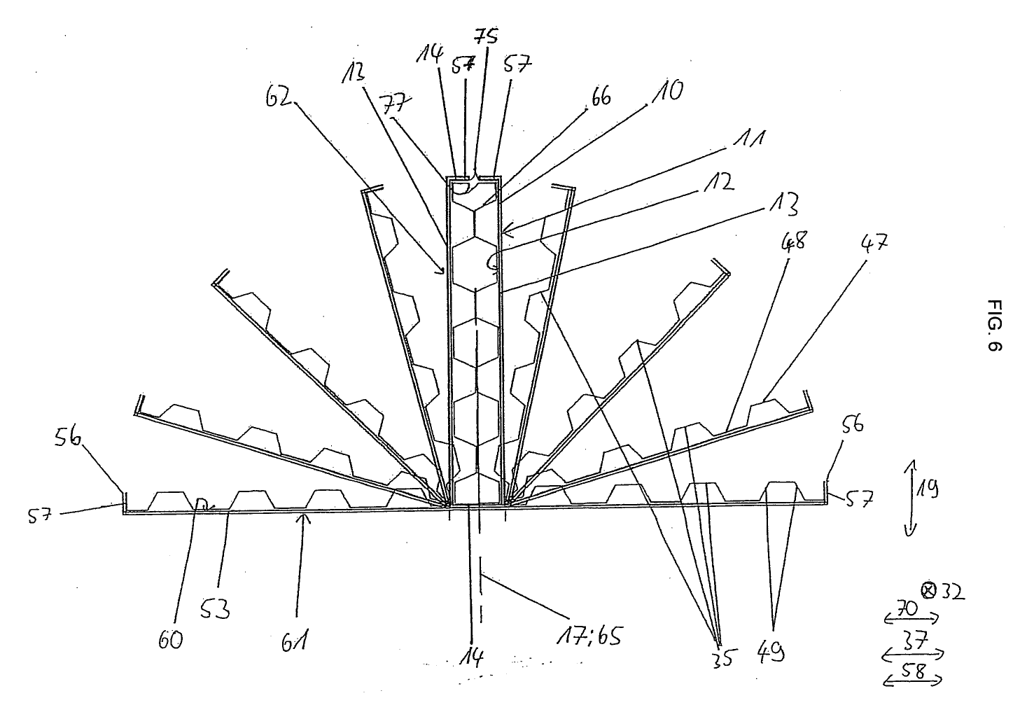

FIG. 6: Schematically, individual steps of the deformation process of the endless flat strip material and the endless profile sheet to produce an endless flat tube having an endless turbulence insert

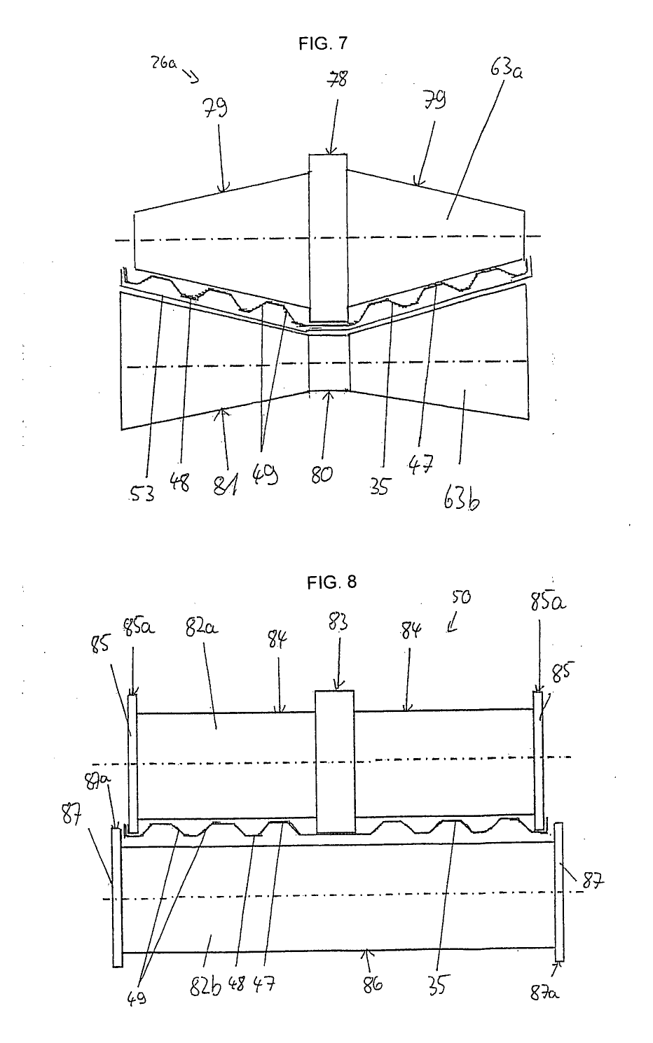

FIG. 7: Schematically, two bending rollers that are disposed one on top of the other

FIG. 8: Schematically, two edging rollers of a first edging device, which are disposed one on top of the other

The heat exchanger 1 according to the invention (FIG. 1) has an inlet collection container 2, an outlet collection container 3 disposed at a distance from the former, multiple flat tubes 4 disposed parallel to one another and next to one another, as well as spaced apart from one another, as well as metal sheets 5 in the form of lamellae or corrugations, preferably disposed between the flat tubes 4, which serve to increase the size of the heat exchanger surface. In this connection, the flat tubes 4 are disposed between the two collection containers 2, 3 and connect them with one another fluidically. The inlet collection container 2 has an inlet opening for letting the first medium to be cooled, particularly charge air, into the inlet collection container 2. The outlet collection container 3 has an outlet opening for letting the cooled first medium out of the outlet collection container 3. In this connection, the inlet opening is preferably followed by an inlet connector piece 6 for a connection to the cooling or heating system, and the outlet opening is followed by an outlet connector piece 7 for a connection to the cooling or heating system. The heat exchanger 1 according to the invention is thus a counter-current heat exchanger, in which a first liquid or gaseous medium to be cooled, i.e. giving off heat, flows from the inlet collection container 2 through the flat tubes 4 into the outlet collection container 3, in a flow direction 8, and is cooled in doing so. Cooling takes place by means of heat exchange with a second, preferably gaseous medium that cools, i.e. absorbs heat, e.g. air, which flows between the flat tubes 4, around the lamella-like metal sheets 5, perpendicular to the flow direction 8, in a counter-current direction 9, and takes up heat in doing so.

A flat tube 4 according to the invention (FIG. 2) has a tube wall 10, in each instance, with a tube wall outer surface 11 and an inner tube wall surface 12, as well as two tube broad side walls 13 that lie opposite and parallel to one another, and two tube narrow side walls 14 that lie opposite and parallel to one another, by way of which the tube broad side walls 13 make a transition into one another. Both the two tube broad side walls 13 and the tube narrow side walls 14 are preferably configured to be planar, i.e. level, i.e. plate-shaped, so that the flat tube 4 has a rectangular cross-section. However, the tube narrow side walls 14 can be configured to be rounded off or half-round, so that the flat tube has an essentially flat-oval cross-section (not shown). The tube wall 10 furthermore delimits a tube interior that forms a flow channel 16 of the flat tube 4, extending parallel to a longitudinal tube center axis 15. Furthermore, the flat tube 4 according to the invention has a tube center plane 17 that contains the longitudinal tube axis 15 and is disposed centered between the tube broad side walls 13 and parallel to them. The flat tube 4 is preferably configured symmetrical to the tube center plane 17. Furthermore, the flat tube 4 has a longitudinal tube direction 18 that runs parallel to the longitudinal tube axis 15, and a tube width direction 19 that runs perpendicular to the longitudinal tube direction 18 and parallel to the tube center plane 17.

Furthermore, the tube wall 10 is produced by means of rolling deformation, and is closed off longitudinally, particularly by means of a longitudinal weld seam 20 that extends parallel to the longitudinal tube direction 18, and this will be discussed in greater detail below. It is practical if the longitudinal weld seam 20 is disposed on one of the two narrow side walls 14 and centered with reference to the latter, and extends parallel to the longitudinal tube axis 15. Longitudinal tube wall edges, i.e. abutting tube wall edges 75 that lie adjacent to one another, i.e. abut one another (FIG. 6) of the tube wall 10 are welded to one another by means of the longitudinal weld seam 20. However, the longitudinal tube wall edges 75 that lie adjacent to one another can be connected with one another in different manner, for example glued or soldered to one another.

The flat tube 4 according to the invention furthermore has a stabilization insert, i.e. turbulence insert 21 that lies on the inside and is disposed within the flow channel 16, the configuration of which will be discussed in greater detail below. The turbulence insert 21 is usually also referred to as a turbulator or as a fin.

In the following, the production method according to the invention, by means of the device 22 according to the invention, will be described in greater detail:

The device 22 according to the invention (FIG. 3) has a turbulence insert pre-fabrication device 23, a tube wall material pre-fabrication device 24, a merging device 25, multiple bending devices 26a, b, preferably a welding device 27, and a cutting device 29.

The turbulence insert pre-fabrication device 23 has a first supply device 30 for a first metallic endless flat strip material 31 for production of the turbulence insert 21, preferably a punching device 28 that follows the first supply device 30 in a horizontal conveying direction 32, a deformation device 33 that follows the punching device 28 in the conveying direction 32, and a first edging device 50 that follows the deformation device 33.

The supply device 30 is a strip storage unit, for example, and has at least one supply roller 74 from which the metallic first endless flat strip material 31, which is plated with solder on one or both sides, in practical manner, is unwound essentially continuously. In this connection, it is practical if the first endless flat strip material 31 has a wall thickness of 0.05 to 0.5 mm, preferably 0.1 to 0.2 mm. Furthermore, the first endless flat strip material 31 preferably consists of aluminum and/or copper and/or steel. It is practical if guidance of the first endless flat strip material 31 takes place in such a manner that the planar endless flat strip material 31 is oriented horizontally. Furthermore, the supply device 30 preferably has multiple dancer rollers (not shown) that follow the supply roller 74, in known manner, in the conveying direction 32, which rollers are disposed in each instance one behind the other in the conveying direction 32 and vertically offset from one another, and can be moved independent of one another in the vertical direction, so that they can fix in place a variable length of the first flat strip material 31. The first flat strip material 31 is then conveyed further to the punching device 28 by the dancer rollers.

The punching device 28 serves for punching out holes (not shown) from the first endless flat strip material 31. One or more rows of holes that extend parallel to the conveying direction 32 are produced by means of the punching device 28. The holes serve to produce turbulence, and this will be discussed in greater detail below. For this purpose, the punching device 28 has at least two punching rollers that lie opposite one another, between which the first flat strip material 31 is guided through. In this connection, one of the two punching rollers has corresponding punch elements that project, and the other punching roller has corresponding recesses, into which the punch elements can be immersed.

Alternatively to the punching device or in addition to it, an embossing device (not shown) is present for introducing embossed regions that produce turbulence into the first flat strip material 31. The embossing device has two embossing rollers that lie opposite one another, in known manner.

From the punching device 28 or the embossing device, respectively, the first flat strip material 31 is then conveyed further to the deformation device 33.

The deformation device 33 serves for deforming, i.e. forming the first flat strip material 31 into a profiled endless profile sheet 35 having a predetermined cross-section profile (FIG. 4). It is practical if deformation takes place by means of rolling deformation, also called embossing in the following. For this purpose, the deformation device 33 has two deformation rollers, i.e. embossing rollers 34a, 34b that are disposed one on top of the other in the vertical direction, the axes of rotation of which rollers are oriented horizontally and perpendicular to the conveying direction 32, and which are disposed to be vertically aligned with one another. The two embossing rollers 34a, 34b can furthermore be driven in opposite directions of rotation, and are disposed at such a distance from one another that the first flat strip material 31 is embossed when it is guided through between the two embossing rollers 34a, 34b. In order to introduce the embossed regions into the first flat strip material 31, the two embossing rollers 34a, 34b each have embossing surfaces that lie on the outside, cover the circumference, and are essentially cylindrical, which surfaces have the positive or negative embossing shapes of the embossed regions to be produced in the first flat strip material 31. In particular, the embossing surface of the lower embossing roller 34b has positive, convex, i.e. projecting embossing shapes, and the embossing surface of the upper embossing roller 34a has the corresponding negative, concave, in other words inward-domed embossing shapes.

The endless profile sheet 35 that is produced has a profile sheet wall 43, two lateral profile sheet longitudinal edges 36, a first profile sheet broad side 44, and a second profile sheet broad side 45 that lies opposite the first profile sheet broad side 44, a longitudinal extension in the conveying direction 32, and a transverse extension in a profile sheet transverse direction 37 that lies perpendicular to the conveying direction 32. It is practical if the first profile sheet broad side 44 is disposed above the second profile sheet broad side 45.

Viewed from the one of the two longitudinal profile sheet edges 36 and in the profile sheet transverse direction 37, the endless profile sheet 35 at first has a first, outer, non-deformed, embossing-free, planar, plate-shaped section 38. It is practical if the first outer planar section 38 is oriented horizontally. Viewed in the profile sheet transverse direction 37, a first deformed, i.e. profiled, particularly embossed section 39 follows the first outer planar section 38. Viewed in the profile transverse direction 37, a central, non-deformed, embossing-free, planar, plate-shaped section 40 follows the first deformed section 39. The first profile sheet broad side 44 and the second profile sheet broad side 45 of the central planar section 40 are coplanar, in each instance, to the first profile sheet broad side 44 and the second profile sheet broad side 45, respectively, of the first outer, non-deformed section 38. Viewed in the profile transverse direction 37, a second deformed, i.e. profiled, particularly embossed section 41 follows the central planar section 40. Viewed in the profile sheet transverse direction 37, a second outer, non-deformed, embossing-free, planar, plate-shaped section 42 follows the second deformed section 41. The first profile sheet broad side 44 and the second profile sheet broad side 45 of the second outer planar section 42 are coplanar, in each instance, to the first profile sheet broad side 44 and the second profile sheet broad side 45, respectively, of the first outer, non-deformed section 38.

The two deformed sections 39, 41 preferably have a trapezoid profile 46 viewed in cross-section, in each instance. This means that the two deformed sections 39, 41 are configured in the manner of a trapezoid profile sheet, i.e. a trapezoid sheet. The trapezoid profile 46 and thus the deformed sections 39, 41 each have planar, plate-shaped first and second vertex walls 47, 48 that preferably extend horizontally, in each instance, and run parallel to one another, whereby the first vertex walls 47 are disposed offset from, i.e. at a distance from the second vertex walls 38, viewed in the vertical direction and in the profile sheet transverse direction 37. In this connection, it is practical if the first vertex walls 47 are disposed higher than the second vertex walls 48. Furthermore, the first profile sheet broad side 44 and the second profile sheet broad side 45 of the second vertex walls 48 are coplanar, in each instance, to the first profile sheet broad side 44 and the second profile sheet broad side 45, respectively, of the planar sections 38, 40, 42. Furthermore, the first and second vertex walls 47, 48 are disposed alternately, viewed in the profile transverse direction 37. A first vertex wall 47 is connected with a second vertex wall 48 by means of slanted, preferably planar, plate-shaped shank walls 49. In particular, a shank wall 49 encloses an angle α with a first vertex wall 47, whereby 90<α135°. The shank walls 49 and the vertex walls 47, 48, and thus the trapezoid profile 46, have a longitudinal extension in the conveying direction 32.

Preferably, the endless profile sheet 35 is configured symmetrical to a central profile sheet center plane 65 that extends parallel to the conveying direction 32 and perpendicular to the profile sheet transverse direction 37. The profile sheet center plane 65 intersects the endless profile sheet 35 in the central planar region 40. Proceeding from the profile sheet center plane 65, one of the two deformed regions 39, 41 follows the central planar region 40 on both sides, in each instance. In turn, one of the two planar regions 38, 42 follows the two deformed regions 39, 41.

Furthermore, it is practical if the extension of the first vertex walls 47, viewed in the profile sheet transverse direction 37, is smaller than the extension of the second vertex walls 48. Preferably, the first vertex walls 47 have an extension, in the profile sheet transverse direction 37, of 1 to 5 mm. The second vertex walls 48 preferably have an extension, in the profile sheet transverse direction 37, of 1 to 5 mm.

Furthermore, it is practical if the punched holes or the embossed regions that produce turbulence, respectively, are introduced in such a manner that they are present in the shank walls 49 after deformation.

Alternatively to the trapezoid profile 46, the two deformed sections 39, 41 have a different wave profile, viewed in cross-section, in each instance, particularly a sine-like wave profile or a triangular profile or a rectangular profile.

The first edging device 50 serves for edging, i.e. bending the endless profile sheet 35 in the region of the two longitudinal profile sheet edges 36, in other words in the region of the two outer planar sections 38, 42. In particular, the endless profile sheet 35 is angled, i.e. bent by 90°. In this way, two lateral passage walls 51 are formed, which are angled away by 90° with reference to the profile sheet transverse direction 37 and are thus oriented vertically. The two passage walls 51 have one of the two longitudinal profile sheet edges 36 on their end side, in each instance. Edging preferably takes place by means of rolling deformation. As a result, the first edging device 50 has two edging rollers 82a, 82b that are disposed one on top of the other (FIG. 8).

The upper edging roller 82a has a central, cylindrical mantle surface 83 with which the upper edging roller 82a presses down on the central planar section 40. The central mantle surface 83 in turn is followed, on both sides, by two mantle surfaces 84 that again are cylindrical, and have a smaller diameter than the central mantle surface 83 and lie against the first vertex walls 47. An outer edging disk 85 having a cylindrical mantle surface 85a, in each instance, follows the two cylindrical mantle surfaces 84, in each instance. The diameter of the mantle surfaces 85a corresponds to the diameter of the central mantle surface 83. The two mantle surfaces 85a press down on the two outer planar sections 38, 42, whereby, however, part of the second outer planar sections 38, 42 projects beyond the outer mantle surfaces 85a, in each instance.

The lower edging roller 82b has a cylindrical mantle surface 86 that is followed, on the end side, by an outer edging disk 87 having a cylindrical mantle surface 87a, in each instance. The two mantle surfaces 87a have a greater diameter than the central mantle surface 86. The central mantle surface 86 lies against the second vertex walls 48 and part of the outer planar sections 38, 42. The part of the outer planar sections 38, 42 that projects beyond the outer mantle surface 85a of the upper edging roller 82a is bent around between the two edging disks 85, 87.

The tube wall material pre-fabrication device 24 is disposed parallel to the turbulence insert pre-fabrication device 23, particularly below it. The tube wall material pre-fabrication device 24 has a second supply device 52 for a second metallic endless profile flat strip material 53 for the production of the tube wall 10 of the flat tubes 4, and preferably a second edging device 54 that follows the second supply device 52 in the conveying direction 32.

The second supply device 52 is also a strip storage unit, for example, and has at least one supply roller 55 from which the metallic second endless flat strip material 53, which is plated with solder on one or both sides, in practical manner, is unwound essentially continuously. In this connection, it is practical if the second endless flat strip material 53 has a wall thickness corresponding to the wall thickness of the tube wall 10 of the flat tube 4 to be produced, of 0.2 to 0.8 mm, preferably 0.25 to 0.35 mm. Furthermore, the second endless flat strip material 53 preferably consists of aluminum and/or copper and/or steel, whereby it does not have to consist of the same material as the first endless flat strip material 31. Furthermore, the second endless flat strip material 53 has two longitudinal strip edges 56 that extend parallel to the conveying direction 32, as well as a first, preferably horizontal, planar strip broad side 60 and a second, preferably horizontal, planar strip broad side 61. The first strip broad side 60 is preferably disposed above the second strip broad side 61. It is practical if guidance of the second endless flat strip material 53 also takes place in such a manner that the plate-shaped endless flat strip material 53 is oriented horizontally. In particular, the first and second endless flat strip material 31, 53 are both oriented horizontally and are disposed aligned with one another in the vertical direction. The second supply device 52 preferably also has multiple dancer rollers (not shown) that follow the supply roller 55, in known manner, in the conveying direction 32, which rollers are disposed one behind the other in the conveying direction 32 and vertically offset from one another, in each instance, and can be moved independent of one another in the vertical direction, so that they can fix in place a variable length of the second flat strip material 53. The second flat strip material 53 is then conveyed further to the second edging device 54 by the dancer rollers.

The second edging device 54 serves for edging, i.e. bending, i.e. angling away the second endless flat strip material 53 in the region of the two longitudinal strip edges 56. In particular, the second endless flat strip material 53 is angled by 90°. This means that two lateral crosspiece walls 57 (FIG. 5) are formed, which are angled away upward by 90° with reference to a horizontal strip transverse direction 58, and are thus oriented vertically. The two crosspiece walls 57 have one of the two longitudinal strip edges 56 on their end side, in each instance. For edging, the second edging device 54 has an upper and a lower edging roller, analogous to the first edging device 50. The lower edging roller is structured analogous to the lower edging roller 82a of the first edging device 50. It is practical if the upper edging roller has a continuous, cylindrical mantle surface.

The merging device 25 serves to combine the edged endless profile sheet 35 and the edged second endless flat strip material 53, in such a manner that one of the two profile sheet broad sides 44, 45 lies against one of the two strip broad sides 60, 61. The endless profile sheet 35 and the second endless flat strip material 53 are therefore laid against one another on the broad sides. For this purpose, the merging device 25 is disposed to follow the two edging devices 50, 54, in the conveying direction 32. The merging device 25 has multiple deflection and guide rollers 59 for deflecting and merging the endless profile sheet 35 and the second endless flat strip material 53. In particular, the endless profile sheet 35 and the second endless profile strip material 53 are merged in such a manner that the endless profile sheet 35 is laid into the second endless flat strip material 53 and laid onto it. This means that the second profile sheet broad side 45 lies on the first strip broad side 60 and the two passage walls 51 of the endless profile sheet 35 lie against the two crosspiece walls 57 of the second flat strip material 53 on the inside. The endless profile sheet 35 is therefore accommodated in the second flat strip material 53 with lateral shape fit after they have been merged. In particular, it is non-displaceably disposed and guided in the second flat strip material 53, in the profile sheet and strip transverse direction 37, 58, respectively.

The bending devices 26a, b for forming an endless flat tube 62 (FIG. 6) follow the merging device 25 in the conveying direction 32. The second endless flat strip material 53 is bent around axes that run parallel to the conveying direction 32, by means of the bending devices 26a, b, in such a manner that the longitudinally slit tube wall 10 of the flat tube 4 to be produced is formed. In particular, the tube wall 10 has the two tube broad side walls 13 and the two tube narrow side walls 14 and, in practical manner, a rectangular cross-section. For this purpose, the endless flat strip material 53 is bent around bending axes that run parallel to the conveying direction 32, in such a manner that the two longitudinal strip edges 56 abut one another and form two tube wall longitudinal edges 75 that lie opposite one another. Furthermore, the second endless flat strip material 53 is bent in such a manner that the two crosspiece walls 57 are disposed to lie opposite one another, and form one of the two tube narrow side walls 14. For this purpose, the second endless flat strip material 53 is angled away on both sides of a central strip center plane 76 that lies perpendicular to the strip transverse direction 58, by 90°, in each instance, particularly upward. In this connection, the bending regions, i.e. bending edges, i.e. folding edges are at the same distance from the strip center plane 76. In this connection, it is practical if the tube broad side walls 13 of the tube wall 10 of the endless flat tube 66 are oriented vertically, and the two tube narrow side walls 14 are oriented horizontally.

The endless profile sheet 35 is bent around axes that are parallel to the conveying direction 32, by means of the bending devices 26a, b, at the same time with the second endless flat strip material 53, in such a manner that it forms an endless turbulence insert 66 in the shape of a flat tube, slit longitudinally, the cross-section profile of which insert corresponds to the cross-section profile of the turbulence insert 21 of the flat tube 4 to be produced. This means that the endless profile sheet 35 is bent to form the tube-shaped endless turbulence insert 66, whereby the endless turbulence insert 66 is enclosed, i.e. sheathed by the tube wall 10 formed by the second endless flat strip material 53. The endless profile sheet 35 is bent in such a manner that the two longitudinal profile sheet edges 36 abut one another and form longitudinal insert edges 77 (FIG. 6). Furthermore, the endless profile sheet 35 is bent in such a manner that the two passage walls 51 are disposed to lie opposite one another, and are oriented horizontally, in practical manner. For this purpose, the endless profile sheet 35 is angled away by 90°, in each instance, particularly upward, on both sides of the profile sheet center plane 65, in the central planar section 40. In this connection, the bending regions, i.e. bending edges, i.e. folding edges are at the same distance from the profile sheet center plane 65. In this way, the two deformed sections 39, 41 are folded onto one another, so that the first vertex walls 47 of the first deformed section 39 and the first vertex walls 47 of the second deformed section 41 lie opposite one another in pairs, particularly lie against one another in pairs, and the second vertex walls 48 of the first deformed section 39 and the second vertex walls 48 of the second deformed section 41 also lie opposite one another in pairs, but are spaced apart from one another.

The endless turbulence insert 66 that was formed by bending the endless profile sheet 35 and consequently also the turbulence insert 21 of the flat tube 4 to be produced have a circumferential, longitudinally slit insert wall 67. The insert wall 67 has two insert narrow side walls 68 that lie opposite one another and are preferably planar, and two profiled insert broad side walls 69 that lie opposite one another. The insert broad side walls 69 have an extension direction parallel to the tube broad side walls 13, i.e. parallel to the tube width direction 19. In this connection, one of the two insert narrow side walls 68 is formed by the two passage walls 51 that lie opposite one another; the other is formed by the non-angled part of the central planar section 40. In this connection, the insert narrow side walls 68 lie against the tube narrow side walls 14, on the inside, in other words are parallel to them.

The insert broad side walls 69 are mainly formed by the two deformed sections 39, 41. As a result, the two insert broad side walls 69 have the first and second vertex walls 47, 48 that are parallel to one another, in each instance, as well as the shank walls 49, and thus also a trapezoid profile, in each instance. In this connection, the first vertex walls 47 of an insert broad side wall 69 are disposed offset, i.e. at a distance from the second vertex walls 48, viewed in the tube height direction 70 and in the tube width direction 19. Furthermore, the first and second vertex walls 47, 48 of an insert broad side wall 69 are disposed alternately, viewed in the tube width direction 19. Furthermore, the first and second vertex walls 47, 48 of an insert broad side wall 69 extend in the tube width direction 19 and in the longitudinal tube direction 18, i.e. are parallel to the tube center plane 17.

Furthermore, the first vertex walls 47 of the one insert broad side wall 69 and the first vertex side walls 47 of the other insert side wall 69 lie opposite one another in pairs, viewed in a tube height direction 70 perpendicular to the tube width direction 19 and to the longitudinal tube axis 15. In particular, the first vertex walls 47 lie against one another in pairs, in planar manner. The first vertex walls 47 therefore preferably meet in the tube center plane 17. In this connection, the first vertex walls 47 of an insert broad side wall 69 are preferably parallel to the first vertex walls 47 of the other insert broad side wall 69. The second vertex walls 48 of the one insert broad side wall 69 and the second vertex walls 48 of the other insert broad side wall 69 also lie opposite one another, in pairs, viewed in the tube height direction 70, whereby, however, they are spaced apart from one another in the tube height direction 70, in other words do not project into the flow channel 16 all the way to the tube center plane 17. In this connection, the second vertex walls 48 of an insert broad side wall 69 are also preferably parallel to the second vertex walls 48 of the other insert broad side wall 69. In particular, the second vertex walls 48 lie against the inner tube wall surface 12 of the tube wall 10 of the endless flat tube 62 in planar manner, in each instance. The second vertex walls 48 therefore support themselves on the tube wall 10, particularly on the inner tube wall surface 12. An insert broad side wall 69 therefore extends, viewed in the tube height direction 70, preferably only on one side of the tube center plane 17, i.e. from the one tube broad side wall 13 all the way to the tube center plane 17.

Because of the configuration of the vertex and shank walls 47, 48, 49, the endless turbulence insert 66 has a honeycomb-shaped structure, i.e. a honeycomb profile. In particular, the endless turbulence insert 66 has multiple first flow chambers 71, disposed adjacent to one another in the tube transverse direction 70, each having a hexagonal, particularly a regular, i.e. regular hexagonal cross-section, which are delimited, in each instance, by two second vertex walls 48 that lie opposite one another and by the four shank walls 49 that follow them. The first flow chambers 71 furthermore have a longitudinal extension in the direction of the longitudinal tube direction 18. In this connection, the extension of the first flow chambers 71 in the tube height direction 70 corresponds to the tube height, so that the honeycomb-shaped structure is configured in one row.

Furthermore, two second flow chambers 72, in each instance, are formed between two first flow chambers 71, in each instance, which are delimited, in each instance, by a first vertex wall 47, the tube wall 10, and both of the two shank walls 49 that follow the first vertex wall 47. The second flow chambers 72 have a trapezoid cross-section, in each instance, and also a longitudinal extension in the direction of the longitudinal tube direction 18. Two second flow chambers 72 disposed between two first flow chambers 71, in each instance, are disposed in pairs, one above the other, viewed in the tube height direction 70.

Furthermore, two third flow chambers 73 disposed on the tube narrow side, i.e. edge side, i.e. end side are present, which are delimited, in each instance, by one of the two insert narrow side walls 68, two half second vertex walls 48, and two shank walls 49. The third flow chambers 73 therefore have a cross-section of a hexagon cut in half.

As was already explained above, the bending devices 26a, b serve for bending, particularly by means of rolling deformation, of the second endless flat strip material 53, together with the endless profile sheet 35, to produce the longitudinally slit endless flat tube 62 just described (FIG. 6). In this connection, it is practical if two different types of deformation devices, i.e. bending devices 26a, b are present. The first bending devices 26a of the device 22 according to the invention have a lower and an upper deformation roller, i.e. bending roller 63a, 63b, in each instance (FIG. 7), which are disposed above and below the second flat strip material 53 and the endless profile sheet 35 laid into it, in each instance, whereby axes of rotation of the bending rollers 63a, 63b are oriented parallel to the axes of rotation of the embossing rollers 34a, 34b, and aligning with one another in the vertical direction. The two bending rollers 63a, 63b can be driven in opposite directions of rotation with reference to one another, whereby the upper bending rollers 63a have the same direction of rotation as the upper embossing roller 34a, and the lower bending rollers 63b have the same direction of rotation as the lower embossing roller 34b.

The upper bending rollers 63a preferably have a central, cylindrical mantle surface 78 and two conical mantle surfaces 79 that narrow away from the central mantle surface 78, adjacent to it. In this connection, the extension of the central mantle surface 78 in the direction of the axis of rotation of the bending roller 63a, in each instance, corresponds to the extension of a tube narrow side wall 14 of the endless flat profile 62 to be produced, in the tube height direction 70. The lower bending rollers 63b have a central, cylindrical mantle surface 80, in each instance, and two conical mantle surfaces 81 that widen away from the central mantle surface 80, adjacent to it. The upper and lower bending rollers 63a, 63b therefore have a positive/negative shape with regard to one another.

For bending, the central mantle surface 80 of a lower bending roller 63b lies against the second strip broad side 61, i.e. presses directly on it. Furthermore, the two conical mantle surfaces 81 also lie against the second strip broad side 61. The central mantle surface 78 of an upper bending roller 63a supports itself on the central planar section 40, i.e. presses down on it. The two conical mantle surfaces 79 lie against the second vertex walls 48. As a result, the second flat strip material 53 guided through between the two bending rollers 63a, 63b and the endless profile sheet 35 are successively bent, i.e. angled around the upper bending roller 63a, because of the negative/positive shape of the bending rollers 63a, 63b, as rolling takes place. This means that the deformed sections 39, 41 are bent toward one another and toward the upper bending rollers 63a (FIG. 6). In this connection, the degree of widening of the lower conical mantle surfaces 81 toward every subsequent bending device 26 increases slightly, and the degree of narrowing of the upper conical mantle surfaces 79 also increases slightly.

The second flat strip material 53 and the endless profile sheet 35 are bent, by means of the first bending devices 26a, as long as an upper bending roller 63a still has room between the deformed sections 39, 41, in other words the tube wall 10 is not yet completely closed.

Subsequently, the second flat strip material 53 and the endless profile sheet 35 are bent and deformed further by means of the second bending devices 26b, until they have the desired cross-section shape. The second bending devices 26b therefore follow the first bending devices 26a in the conveying direction 32. The second bending devices 26b have only lower bending rollers 63b, in each instance, on which rollers the conicity of the conical mantle surfaces 81 increases successively, until the lateral mantle surfaces 81 are perpendicular to the central mantle surface 80.

In the welding device 27 that follows the last bending device 26b in the conveying direction 32, longitudinal tube wall edges 75 that lie opposite one another are continuously welded to one another in known manner, so that a closed, pre-fabricated endless flat tube 62 is formed. During welding, the two longitudinal tube wall edges 75 are pressed against one another by means of pressure rollers, for example, which engage on the two tube broad side walls 13, and the material in the region of the longitudinal tube wall edges 75 is heated, in such a manner that it welds together, forming the longitudinal weld seam 20. It is practical if welding takes place by means of induction welding.

Preferably, however, not only the two longitudinal tube wall edges 75 but also, at the same time, the two longitudinal insert edges 77 are welded to one another in the welding device 27. This means that by means of pressing together the two longitudinal tube wall edges 75, the two longitudinal insert edges 77 are also pressed against one another, and the material in the region of the longitudinal insert edges 77 is also heated, in such a manner that it is welded together. It is practical if, in this connection, only one weld seam, namely the longitudinal weld seam 20, is formed, so that in addition, the tube wall 10 and the endless turbulence insert 66 are welded to one another by way of the longitudinal weld seam 20, so that the tube wall 10 and the endless turbulence insert 66 are firmly connected with one another.

Furthermore, the longitudinal insert edges 77 can also be merely soldered to one another due to the heat effect during welding of the longitudinal tube wall edges 75. For this purpose, it is practical if flux is present, which is present on the longitudinal insert edges 77, preferably on the inside.

Alternatively to welding or soldering the longitudinal insert edges 77, or in addition to this, the slit insert narrow side wall 68 is soldered to the inner tube wall surface 12 due to the heat effect during welding, so that the tube wall 10 and the endless turbulence insert 66 are firmly connected with one another in this way.

Furthermore, the flat tube 4 can also be connected longitudinally, in the region of the two longitudinal tube wall edges 75, by means of a known folding connection, or in some other way.

In place of the welding device 27, of course, any other type of connection device, for example a soldering device or a gluing device, can also be provided.

It is practical if the cutting device 29 of the device 22 according to the invention has a blade (not shown) for cutting the endless flat tube 62 along a preferably vertical cutting line, so that the endless flat tube 62 is cut into individual flat tubes 4 having the desired tube length. For cutting, the blade is pivoted or rotated about a horizontal axis, for example, parallel to the conveying direction 32. In addition, the blade can also be moved along in the conveying direction 32 during the cutting process, in known manner, in order to balance out the advancing movement of the endless flat tube 62 (“floating blade”). According to a preferred embodiment of the invention, however, the blade is non-displaceable in the conveying direction 32 (“standing blade”), whereby the movement of the endless flat tube 62 is balanced out by a corresponding shape of the blade that balances out the movement of the endless tube 62, which shape is slanted in the conveying direction 32, or by a corresponding slanted position of the blade.

The cut flat tubes 4 are subsequently still soldered in a soldering oven. Because of the solder plating of the first and second endless flat strip material 31, 53, preferably on both sides, the first vertex walls 47 that lie on top of one another, in pairs, are soldered to one another, and the second vertex walls 48 are soldered to the inner tube wall surface 12. In this way, a firm composite of turbulence insert 21 and tube wall 10 is formed.

It is advantageous in the case of the production method according to the invention, by means of the device 22 according to the invention, for one thing, that the flat tube 4 according to the invention, together with the turbulence insert 21, is produced continuously, i.e. on-line. As a result, the flat tube 4 can be produced in fast and cost-advantageous manner.

If the endless turbulence insert 66 and the tube wall 10 are firmly connected with one another during welding, the endless turbulence insert 66 can no longer slip within the tube wall 10. As a result, the endless flat tube 62 can be cut in the cutting device 29 without problems. Furthermore, the flat tubes 4 produced can also be cut to length by hand, by means of a saw, at a later point in time, without any problems, without previously having been in a soldering oven.

Furthermore, both the shape-fit placement of the turbulence insert 21 within the tube wall 10 and the flat tube shape of the turbulence insert 21 have the advantage that the turbulence insert 21 supports the tube wall 10, so that the stability of the flat tube 4 according to the invention, particularly the pressure resistance in the case of pressure on the tube broad side walls 13, is significantly increased. Furthermore, the bursting strength is improved, particularly if the turbulence insert 21 is also closed longitudinally, particularly welded. If the turbulence insert 21 is soldered to the tube wall 10 over a large area, the strength is further increased. Furthermore, the heat exchange is improved by means of the profiled broad sides 44, 45 and the formation of the flow chambers 71, 71, 73.

The honeycomb-shaped structure of the turbulence insert 21, in particular, improves the stability of the flat tube 4 even further. This is because the first vertex walls 47 that lie against one another in pairs support themselves against one another, in planar manner, in the region of the tube center. As a result, the insert broad side walls 69 support one another in the tube height direction 70. Furthermore, the second vertex walls 48 support themselves, in planar manner, on the tube wall 10. Thus, great pressure forces can be absorbed in the case of outside pressure. The slanted shank walls 49 ensure optimal force transfer, in this connection.

The stability of the flat tube 4 is further increased, in particular, if the turbulence insert 21 is soldered to the tube wall 10, and the first vertex walls 47 that lie on top of one another are also soldered to one another. This is because the shank walls 49 are firmly clamped in at their two ends, in each instance. Furthermore, the shank walls 49 have a lesser extension, viewed perpendicular to the longitudinal tube direction 18, than conventional wave fins, whose shank walls extend over the entire tube height, from one tube broad side wall to the other. This is because the shank walls 49 preferably extend only over half the tube height, in each instance. For this reason, as well, the shank walls 49 have a lesser tendency to bend outward under pressure stress.

Also, the turbulence inserts 21 act as tie rods, so that the flat tubes 4 also withstand great inside pressures.

Since the stability is clearly improved, particularly because of the honeycomb-shaped structure, the wall thickness of the turbulence insert 21 can be very slight. Preferably, it lies at 0.05 to 0.5 mm, preferably 0.1 to 0.2 mm. In this way, material is saved, on the one hand. On the other hand, the surface of the vertex walls 47, 48 and the shank walls 49, which the heat exchanger medium flowing through the flat tube 4 impacts when entering into the flat tube 4, is reduced in size. Thus, the pressure losses are clearly reduced.

As has already been explained above, it furthermore lies within the scope of the invention to introduce other types of profiling into the endless profile sheet 35, so that the two deformed sections 39, 41, alternatively to the trapezoid profile 46, have a different wave profile, for example a sine-like wave profile or a triangular profile or a rectangular profile, viewed in cross-section, having first and second vertex walls or vertices, in each instance. In this connection, it is practical if the endless profile sheet 35 is bent in such a manner, in each instance, that the first vertex walls, i.e. vertices of the insert broad side walls 69 that lie opposite one another come to lie on top of one another, in pairs, in order to guarantee the support effect described. The two insert broad side walls 69 therefore support themselves on one another, preferably at multiple locations, in the tube height direction 70. Furthermore, the second vertex walls or vertices of the two insert broad side walls 69 that lie opposite one another preferably lie against the tube wall 10, particularly the tube broad side wall 13, in each instance, and support themselves on it. Furthermore, in analogous manner as in the case of the trapezoid profile, first flow chambers are formed, which are delimited, in each instance, by second vertex walls, i.e. vertices of the two insert broad side walls 69 that lie opposite one another and the four shank walls that follow the two second vertex walls, i.e. vertices. The second flow chambers are also delimited, in analogous manner as in the case of the first trapezoid profile, by the first vertex walls, i.e. vertices, the two shank walls that follow the first vertex walls, i.e. vertices, as well as the tube wall 10.

The advantage of the trapezoid profile 46, however, is the honeycomb structure that results from it when bending and folding onto one another the deformed sections 39, 41. This is because in the case of the trapezoid profile 46, slight deformation tolerances are not harmful, since a slight offset of the first vertex walls 47 that lie on top of one another, in the tube width direction 19, relative to one another, is not harmful, because there is still sufficient contact surface available.

When viewed thermodynamically, as well, the flat tubes 4 according to the invention are configured very advantageously, particularly due to the honeycomb form of the turbulence insert 21. This is because the first vertex walls 47 advantageously lie on top of one another in the region of the tube center. Thus, regions having a double wall thickness are formed there. However, the region of the tube center is the region in which the temperature of the flow medium flowing through the flat tube 4 is the highest, in other words the most heat has to be carried away. Since heat conductance in the flat tube 4 takes place by way of the insert wall 67 of the turbulence insert, for the most part, heat removal is optimized by the double wall thickness in the region of the tube center.

Furthermore, it is advantageous that even very long tubes can be produced using the method according to the invention, which tubes are only cut into individual, shorter flat tubes having a desired length later. This is not possible in the case of the multi-stage process according to the state of the art, since insertion of the turbulence inserts is no longer possible, starting from a specific tube length.

It furthermore lies within the scope of the invention to pull the first endless flat strip material 31 and the second endless flat strip material 53 off a common supply device, particularly from a common supply roller. Subsequently the two endless flat strip materials 31, 53 run apart from one another, whereby the first endless flat strip material 31 is deformed, if necessary punched and edged, as described above. The second endless flat strip material 53 is also edged. Subsequently, merging takes place as described above. The fact that the endless flat strip materials 31, 53 and/or the endless profile sheet 35 are always under sufficient tension is guaranteed with known means, for example dancer rollers.

Furthermore, it also lies within the scope of the invention to edge the endless profile sheet 35 and the second endless flat strip material 53 jointly only after merging and before bending. This takes place, for example, by means of two edging rollers disposed one on top of the other, which are configured analogous to the edging rollers for edging the endless profile sheet 35.

Furthermore, the turbulence insert 21 can also consist of two individual profiled single sheets that lie on top of one another, which are disposed in such a manner that they support themselves on one another and preferably on the tube wall 10, and preferably form the honeycomb-shaped structure described above. The two single sheets then form an insert broad side wall 69, in each instance. Production of such a flat tube 4 takes place, for example, by means of pushing the two single sheets into the pre-fabricated flat tube. It is practical if the single sheets are soldered to one another at their contact locations.

The two insert broad side walls 69 of the turbulence insert 21 that support themselves on one another furthermore do not have to have the same kind of profiling, but rather can also have different wave profiles or similar wave profiles having different dimensions. Preferably, in this connection, the first vertex walls, i.e. vertices of the two insert broad side walls 69 that lie opposite one another again support themselves on one another, whereby it is not necessary that each vertex wall, i.e. each vertex must support itself on a vertex wall, i.e. on a vertex of the opposite insert broad side wall 69.

Furthermore, independent of the type of profiling, it is also not necessary for each first vertex walls, i.e. each vertex of the two insert broad side walls 69 that lie opposite one another must support itself on the tube wall 10, particularly the tube broad side wall 13, in each instance.

Furthermore, the turbulence insert 21 can also be slit longitudinally, in such a manner that the longitudinal insert edges 77 do not abut one another, but rather are spaced apart from one another. For example, the endless profile sheet 35 is not edged during production, in the region of the longitudinal profile sheet edges 36. The endless turbulence insert 66 produced from this endless profile sheet 35, i.e. the subsequent turbulence insert 21, then has only one insert narrow side wall 68.

1. Method for continuous production of flat tubes (4) having a turbulence insert (21) that lies inside the tubes, having the following method steps:
a) making available a first metallic endless flat strip material (31), particularly by means of continuous discharge of the first metallic endless flat strip material (31) from a first supply device (30),
b) deforming the first endless flat strip material (31), particularly by means of two embossing rollers (34a; 34b) that can be rotated in opposite directions of rotation, between which the first endless flat strip material (31) is passed through in a conveying direction (32), into a profiled endless profile sheet (35) having two lateral longitudinal profile sheet edges (36) and two profile sheet broad sides (44, 45),
c) making available a second endless flat strip material (53) having two lateral longitudinal strip edges (56) and two strip broad sides (60, 61), particularly by means of continuous discharge of the second endless flat strip material (53) from a second supply device (52),
d) merging the endless profile sheet (35) and the second endless flat strip material (53), in such a manner that these lie against one another with their broad sides,
e) continuous bending, preferably by means of rolling deformation, of the second endless flat strip material (53), together with the endless profile sheet (35), to form an endless flat tube (62) having a longitudinally slit tube wall (10) having two longitudinal tube wall edges (75) that lie opposite one another, and a longitudinally slit turbulence insert (66) having two longitudinal edges, i.e. abutting edges (77), which preferably lie opposite one another whereby the tube wall (10) encloses the endless turbulence insert (66),
f) connecting, particularly welding the two longitudinal tube wall edges (75) and preferably the two longitudinal insert edges (77) to one another,
g) cutting the endless flat tube (62) to length into individual flat tubes (4).

2. Method according to claim 1, wherein
the endless profile sheet (35), after deformation and before merging, is edged by 90°, in each instance, in the region of its two longitudinal profile sheet edges (36), and preferably the second endless flat strip material (53), before merging, is edged by 90°, in each instance, in the region of its two lateral longitudinal strip edges (56).

3. Method according to claim 2, wherein
during edging of the endless profile sheet (35), two lateral passage walls (51) are formed, which are angled away by 90° with reference to a profile sheet transverse direction (37) and have one of the two longitudinal profile sheet edges (36) on their end side, in each instance, and, in practical manner, during edging of the second endless flat strip material (53), two lateral crosspiece walls (57) are formed, which are angled away by 90° with reference to a strip transverse direction (58) and have one of the two longitudinal strip edges (56) on their end side, in each instance.

4. Method according to claim 1, wherein
the first endless flat strip material (31) is deformed in such a manner that the endless profile sheet (35) is configured symmetrical to a central profile sheet center plane (65) that extends parallel to the conveying direction (32) and perpendicular to a profile sheet transverse direction (37).

5. Method according to claim 4, wherein
an endless profile sheet (35) is produced, which, proceeding from the profile sheet center plane (65), has a central planar region (40), deformed regions (39, 41) that follow the central region (40) on both sides, and outer planar regions (38, 42) that follow each of the two deformed regions (39, 41).

6. Method according to claim 5, wherein
the first endless flat strip material (31) is deformed in such a manner that the two deformed sections (39, 41) have a wave profile, particularly a trapezoid profile (46) or a sine-like wave profile or a triangular profile or a rectangular profile, viewed in cross-section, in each instance.

7. Method according to claim 6, wherein
the first endless flat strip material (31) is deformed in such a manner that the deformed sections (39, 41) have first and second planar, plate-shaped vertex walls (47, 48) that run parallel to one another, in each instance, whereby the first vertex walls (47), viewed in the profile sheet transverse direction (37) and in a direction perpendicular to the conveying direction (32) and to the profile sheet transverse direction (37), are disposed offset relative to the second vertex walls (48), whereby the first and second vertex walls (47, 48), viewed in the profile sheet transverse direction (37), are disposed alternately.

8. Method according to claim 7, wherein
the first endless flat strip material (31) is deformed in such a manner that a first vertex wall (47) is connected with a second vertex wall (48), in each instance, by means of slanted, preferably planar, plate-shaped shank walls (49).

9. Method according to claim 3, wherein
during merging, the endless profile sheet (35) is laid into the second endless flat strip material (53) and laid onto it, so that a second profile sheet broad side (45) lies on a first strip broad side (60), and preferably, the two passage walls (51) of the endless profile sheet (35) lie against the two crosspiece walls (57) of the second flat strip material (53), on the inside.

10. Method according to claim 1, wherein
the second endless flat strip material (53) is bent in such a manner that the longitudinally slit tube wall (10) has two tube broad side walls (13) and two tube narrow side walls (14), and, in practical manner, a rectangular cross-section.

11. Method according to claim 10, wherein
the second endless flat strip material (53) is bent in such a manner that the two longitudinal strip edges (56) abut one another and form the two longitudinal tube wall edges (75) that lie opposite one another, and, in practical manner, the two crosspiece walls (57) are disposed to lie opposite one another and form one of the two tube narrow side walls (14).

12. Method according to claim 11, wherein
the second endless flat strip material (53) is bent on both sides of a central strip center plane (76) that lies perpendicular to the strip transverse direction (58), by 90°, in each instance, particularly upward, whereby the bending regions are at the same distance from the strip center plane (76).

13. Method according to claim 1, wherein
the endless profile sheet (35) is bent in such a manner that the two longitudinal profile sheet edges (36) abut one another and form the longitudinal insert edges (77).

14. Method according to claim 3, wherein
the endless profile sheet (35) is bent in such a manner that the two passage walls (51) are disposed to lie opposite one another and, in practical manner are oriented horizontally.

15. Method according to claim 5, wherein
the endless profile sheet (35) is bent on both sides of the profile sheet center plane (65), in the central planar section (40), by 90°, in each instance, particularly upward, whereby the bending regions are at the same distance from the profile sheet center plane (65).

16. Method according to claim 5, wherein
during bending, the two deformed sections (39, 41) are folded onto one another, particularly in such a manner that the first vertex walls (47) of the first deformed section (39) and the first vertex walls (47) of the second deformed section (41) lie opposite one another in pairs, particularly lie against one another in pairs, and the second vertex walls (48) of the first deformed section (39) and the second vertex walls (48) of the second deformed section (41) also lie opposite one another in pairs, but are spaced apart from one another.

17. Method according to claim 1, wherein
the two longitudinal tube edges (75) and the two longitudinal insert edges (77) are welded to one another by means of forming a longitudinal weld seam (20), so that the tube wall (10) and the endless turbulence insert (66) are welded to one another by way of the longitudinal weld seam (20).

18. Method according to claim 1, wherein
the longitudinal insert edges (77) are soldered to one another due to the heat effect during welding of the longitudinal tube wall edges (75).

19. Method according to claim 1, wherein
because of the heat effect, the endless turbulence insert (66) is soldered to the tube wall (10), in certain regions, during welding.

20. Device (22) for continuous production of flat tubes (4) having a turbulence insert (21) that lies inside the tubes, respectively, particularly according to the method according to claim 1, which has
a) a turbulence insert pre-fabrication device (23) having a deformation device (33) having means for deforming a first metallic endless flat strip material (31) to produce a profiled endless profile sheet (35) having two lateral longitudinal profile sheet edges (36) and two profile sheet broad sides (44, 45),
b) means for making available a second metallic endless flat strip material (53) having two lateral longitudinal strip edges (56) and two strip broad sides (60, 61),
c) a merging device (25) having means for merging the endless profile sheet (35) and the second endless flat strip material (53), so that these lie against one another with their broad sides,
d) multiple bending devices (26a, b) disposed one behind the other in a conveying direction (32), for continuous bending, preferably by means of rolling deformation, of the second endless flat strip material (53) together with the endless profile sheet (35), to produce an endless flat tube (62) having a longitudinally slit tube wall (10) having two longitudinal tube wall edges (75) that lie opposite one another and a longitudinally slit endless turbulence insert (66) having two longitudinal or abutting edges (37) that preferably lie opposite one another whereby the tube wall (10) encloses the endless turbulence insert (66),
e) a connecting device, particularly a welding device (27), for connecting the two longitudinal tube wall edges (75) and preferably the two longitudinal insert edges (77) with one another,
f) and a cutting device (29) for cutting the endless flat tube (62) into individual flat tubes (4).

21. Device according to claim 20, wherein
the deformation device (33) has two embossing rollers (34a, 34b) for embossing the first metallic endless flat strip material (31), disposed on top of one another in the vertical direction and mounted to rotate.

22. Flat tube (4) for heat exchangers, having a tube wall (10) that has two tube broad side walls (13) that lie opposite one another and two tube narrow side walls (14) that lie opposite one another, by way of which the tube broad side walls (13) make a transition into one another, and having a turbulence insert (21) disposed within the tube wall (10), particularly produced according to claim 1, wherein
the turbulence insert (21) has two profiled insert broad side walls (69) that lie opposite one another, which support themselves on one another in certain regions, i.e. at certain locations, and, in practical manner, on one of the two tube broad side walls (13), in each instance, in certain regions, i.e. at certain locations.

23. Flat tube (4) according to claim 22, wherein
the turbulence insert (21) is configured in the shape of a flat tube and has an insert wall (67) having the two profiled insert broad side walls (69) that lie opposite one another and two insert narrow side walls (68) that lie opposite one another and are preferably planar, by way of which the insert broad side walls (69) make a transition into one another.

24. Flat tube (4) according to claim 23, wherein
the insert wall (67) is longitudinally slit.

25. Flat tube (4) according to claim 23, wherein
the insert narrow side walls (68) lie against the tube narrow side walls (14) on the inside, with shape fit.

26. Flat tube (4) according to claim 22, wherein
the two insert broad side walls (69) have a wave profile, particularly a trapezoid profile (46) or a sine-like wave profile or a triangular profile or a rectangular profile, viewed in cross-section, in each instance.

27. Flat tube (4) according to claim 26, wherein
the two insert broad side walls (69) have first and second, preferably planar, plate-shaped vertex walls (47, 48), in each instance, that preferably extend parallel to the tube broad side walls (13), whereby the first vertex walls (47) are disposed offset relative to the second vertex walls (48), viewed in a tube height direction (70) and in a tube width direction (19), whereby the first and second vertex walls (47, 48) are disposed alternatively, viewed in the tube width direction (19).

28. Flat tube (4) according to claim 27, wherein
a first vertex wall (47), in each instance, is connected with a second vertex wall (48) by means of a slanted, preferably planar, plate-shaped shank wall (49).

29. Flat tube (4) according to claim 27, wherein
the first vertex walls (47) of the one insert broad side wall (69) and the first vertex walls (47) of the other insert broad side wall (69) lie opposite one another, in pairs, viewed in the tube height direction (70), and lie against one another in planar manner, in pairs.

30. Flat tube (4) according to claim 27, wherein
the second vertex walls (48) of the one insert broad side wall (69) and the second vertex walls (48) of the other insert broad side wall (69) lie opposite one another, in pairs, viewed in the tube height direction (70), whereby they are spaced apart from one another in the tube height direction (70).

31. Flat tube (4) according to claim 30, wherein
the second vertex walls (48) lie against the inner tube wall surface (12) of the tube wall (10) of the flat tube (4).

32. Flat tube (4) according to claim 27, wherein
the turbulence insert (21) has a honeycomb profile.

33. Flat tube (4) according to claim 32, wherein
the turbulence insert (21) has multiple first flow chambers (71), disposed adjacent to one another in the tube transverse direction (70), each having a hexagonal, particularly a regular hexagonal cross-section, which are delimited particularly by two second vertex walls (48) that lie opposite one another and by the four shank walls (49) that follow them.

34. Flat tube (4) according to claim 33, wherein
the extension of the first flow chambers (71) in the tube height direction (70) corresponds to the tube height, so that the honeycomb-shaped structure is configured in one row.

35. Flat tube (4) according to claim 22, wherein
the flat tube (4) has multiple first and second flow chambers (71, 72) that extend in the longitudinal tube direction (18), whereby two second flow chambers (72) are disposed between two first flow chambers (71), in each instance, whereby the two second flow chambers (72) disposed between two first flow chambers (71) are disposed on top of one another, viewed in the tube height direction (70).

36. Flat tube (4) according to claim 22, wherein
the insert broad side walls (69) are profiled in such a manner that they support themselves on one another, in the tube height direction (70).

37. Flat tube (4) according to claim 22, wherein
the insert broad side walls (69) have a wave profile with first and second vertex walls or vertices, in each instance, whereby the first vertex walls or vertices of the two insert broad side walls (69) that lie opposite one another, particularly in pairs, lie against one another, and, in practical manner, at least a part of the second vertex walls or vertices supports itself on one of the two tube broad side walls (13).

38. Flat tube (4) according to claim 22, wherein
the tube wall (10) is produced by means of rolling deformation and preferably welded longitudinally by means of a longitudinal weld seam (20), and preferably the turbulence insert (21) is also produced by means of rolling deformation and welded longitudinally by means of the longitudinal weld seam (20), so that the tube wall (10) and the turbulence insert (21) are welded to one another by way of the longitudinal weld seam (20).

39. Heat exchanger (1), comprising
flat tubes (4) according to claim 22.
